(19) United States
(12) Patent Application Publication
(10) Pub. No.: US 2008/0034254 A1
(43) Pub. Date: Feb. 7, 2008

(54) Test system and method

(76) Inventor: Jimmy D. Saunders, Georgetown, TX (US)

Correspondence Address: ARNOLD & KNOBLOCH, L.L.P., 2401 FOUNTAIN VIEW DRIVE, SUITE 630, HOUSTON, TX, 77057, US

(21) Appl. No.: 11/906,808

(22) Filed: Oct. 4, 2007

Related U.S. Application Data
(63) Continuation of application No. 11/109,295, filed on Apr. 19, 2005.
Application No. 11/109,295 is a continuation of application No. 10/005,639, filed on Dec. 4, 2001, now abandoned.

(51) Int. Cl. G06F 11/00

(52) U.S. Cl. 714/25; 714/E11.148

(57) ABSTRACT

A system and method for configuration of general purpose test equipment is provided. According to various examples of the invention, performance specification documents in electronic form are input using mark-up language and a mark-up language reader converts the performance specification document into, selectively, a human readable document and a delimited configuration file for input into configurable test equipment having a common object request broker architecture.

### CROSS-REFERENCE TO RELATED APPLICATIONS

This application is a continuation of application Ser. No. 11/109,295, filed Apr. 19, 2005, which is a continuation of application Ser. No. 10/005,639, filed Dec. 4, 2001, to which the instant application claims priority.

### BACKGROUND

Electronic systems must be tested. Failure of such systems during operation is considered to be catastrophic in many situations (for example, space-craft and missiles). Expensive suites of test equipment have been developed to test complex, high-value electronic systems. These test systems are matched to the design of the system to be tested. Therefore, the test equipment development cannot start until the system to be tested is far down the design and development road, and the amount of time available to develop the test equipment is very short. In addition, inevitable changes to the design of the complex system to be tested, after test equipment development, result in a high cost to modify the test equipment to reflect that change. Therefore, there is a need for a test equipment system that can be changed rapidly.

The test equipment is designed to a specification document, usually a “performance specification” or a “requirements” document. During the process of designing the test equipment from the performance specification, elements of the point design of the equipment to be tested tend to “leak back” into the specification. Therefore, there is a need for test equipment design that, while being driven by the requirements of the tests to be performed, is derived independently.

Generally, test equipment can be divided into two categories. The first category is termed Special Test Equipment (STE). This is equipment developed to perform a specific testing function. It is not suitable for testing items other than those it was designed to test. In contrast, General Purpose Test Equipment is used to test many unrelated components or systems. Unfortunately, current stand alone General Purpose Test Equipment is unsuitable for, most complex systems; the embedded functionality is too inflexible. Therefore, there is a need for a Several Purpose Test System that will service highly complex systems.

For example, for missiles, onboard performance information during flight must be transmitted to ground receiver sites. A system of sensors, processors and telemetry transmitters is used to collect and transmit performance data and missile range safety tracking information to the ground control site. A system of ground-test instrumentation is used to check out the system of flight instrumentation and telemetry equipment. Currently, as the performance and tracking system is developed, a special test equipment suite is developed at the same time. Detailed system test requirements documentation is not finalized until late in development; therefore, the start of the test equipment development effort is delayed. Furthermore, the inevitable modifications to the system will cause the test equipment development to incur cost and schedule growth. Even further, post-development alterations of the system result in a high cost modification of the special test equipment. The hard-wired architecture of the test equipment results in a disincentive to modify system flight hardware due to the high cost of changing the test equipment. Accordingly, there is a need to develop general purpose test equipment capable of handling specific systems, such as the example system above.

There is also a need to reduce the schedule risks in development programs of test equipment and to provide a structure for increasing the assurance that performance requirements alone will drive the test equipment specification, and there is a need for test equipment design that requires a more clear and more complete definition of performance specification of test equipment early in the development process.

### SUMMARY OF THE INVENTION

According to a first aspect of the invention, a general purpose test equipment system is provided, the system comprising: hardware having common object request broker architecture software and a mark-up language enabled input connected to the hardware. According to a specific example embodiment of the invention, the mark-up language enabled input is configured for acceptance of a delimited configuration file. According to a further example, the mark-up language comprises XML, SGML, or HTML. Other mark-up languages will occur to those of skill in the art. In still a further example embodiment, the mark-up language enabled input comprises a mark-up language reader configured to receive a performance specification document arid output a delimited configuration file.

In one specific example, the reader selectively outputs a human readable document corresponding to the performance specification document. In another specific example, the performance specification document comprises: an order of test operations to be performed on equipment, wherein the order of test operations is defined in mark-up language, a specification of system interfaces for the application of stimulus to and the collection of measurements from the system during test operations, wherein the specification is defined in mark-up language, a specification of units and values to be applied to the equipment during test operations, wherein the specification is defined in mark-up language, a specification of units and values to be measured during test operations, an identification of a test system response to failure, a specification for collection of test results, and a specification for storage of test results.

According to another aspect of the invention, a method of configuring test equipment is provided, the method comprising: inputting, in mark-up language format: an order of test operations, a specification of system interfaces for the application of stimulus to and the collection of measurements from the system during test operations units and values to be applied to the equipment during test operations, units and values to be measured during test operations, a test system response to a failure, a specification of collection of test results, and a specification of storage of test results. The method further comprises generating a delimited configuration file, dependent upon said inputting; and entering the delimited configuration file into test equipment. In more specific example embodiments, the mark-up language comprises SGML, XML, or HTML. According to still a more detailed example, the method further comprises generating a human-readable document dependent upon said entering.

According to still another aspect of the invention, a system is provided for configuring test equipment, the system comprising: means for inputting, in mark-up language format: an order of test operations, a specification of system interfaces for the application of stimulus to and the collection of measurements from the system during test operations, units and values to be applied to the equipment during test operations, units and values to be measured during test operations, a test system response to a failure, a specification of collection of test results, a specification of storage of test results, means for generating a delimited configuration file, dependent upon said means for inputting; and means for entering the delimited configuration file into test equipment. As before, in specific example embodiments, the mark-up language comprises SGML, XML, or HTML. Also, as before, in a still more specific example embodiment, a means is provided for generating a human-readable document dependent upon said means for entering.

### BRIEF DESCRIPTION OF THE DRAWINGS

FIG. 1 shows a flow diagram of an example embodiment of the invention.

### DESCRIPTION OF EXAMPLE EMBODIMENTS OF THE INVENTION

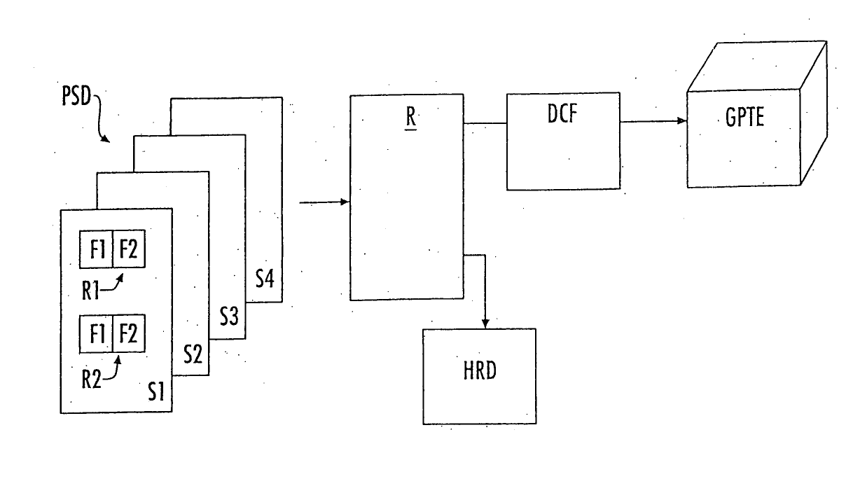

Referring now to FIG. 1, an example embodiment of the invention is seen in which performance specification document (PSD) is provided in an electronic form in an electronic document mark-up language (for example, Standard Generalized Mark-up Language (SGML)). According to one specific embodiment of the invention, electronic document PSD is in the Extensible Mark-up Language (XML). A specific advantage of the XML embodiment is that XML uses tags only to delimit pieces of data and leaves the interpretation of the tag completely to the application reading the data. According to an alternative embodiment, the electronic performance specification document (PSD) comprises a Hyper-Text Mark-up Language (HTML) document.

As seen in FIG. 1, the performance specification document includes data in fields (for example, F1 and F2), contained in records (R1 and R2)). The various records and fields of the performance specification document are included in various sections S1-S4. The sections, fields and records are demarked by tags and attributes defined by formatting rules. The tags and records include hierarchical divisions (for example, sections, jobs, blocks, steps, etc.). Further, the rules include which subdivisions are required and which are optional in various embodiments.

According to other embodiments, the rules define which of fields F1 and F2 are required for the definition of the smallest record. According to one specific example, assuming a record is the smallest section of the performance specification document, the required fields include descriptions of instructions, notes, test-interface points, stimulus values, stimulus value units, measured values, measured value units, etc. The tags and attributes, therefore, include: (1) documentation related items such as hierarchical notations, titles, descriptions, and notes; (2) test system related items (e.g., interface points and data codes); and (3) test specific items (e.g., stimulus and measurement values and units).

According to other specific example embodiments, additional rules constraining the performance specification document (PSD) are derived from test specifications and testing requirements for the unit under test. In some specific examples, those rules include the order of events (testing is required, in some embodiments, to proceed in a specific order to make a valid assessment of some functionality of interest) and lists of acceptable units (for example, the use of volts as a specification may be constrained to units of V).

Referring still to FIG. 1, the performance specification document (PSD) is read by mark-up language reader R which selectively generates delimited configuration file (DCF) and/or human readable document (HRD). Delimited configuration file (DCF) is used by general purpose test equipment (GPTE) to configure test equipment to test the system of interest (not shown). Human-readable document (HRD) is used by operation and quality-control personnel to review the design of the test.

As a result of the example embodiment of FIG. 1, parallel development of the test equipment and the system to be tested is provided, and changes to the system to be tested occur without changing the test system. Further, the traditional path for corruption of the performance specifications and requirements is eliminated by decoupling the requirements and specification development from the test equipment point design. Providing the detailed test parameters and the delimited configuration file DCF allows for changes to the performance specification without changing the hardware or detailed software design of the test equipment. Thus, development of test equipment occurs sooner; changes during development have less impact on test equipment development; and the fully-developed performance specification eliminates the need for test equipment driven changes to the performance specification.

In one specific example embodiment, a performance specification document for a system calls for a system battery voltage test. The performance specification document includes the following definitions of related XML tags and attributes in accordance with World Wide Web Consortium XML Standards:

<!ELEMENT section (section_name_id, section_description,
section_note*, io_block+)>

| | |
|---|---|
| <!ELEMENT section_name_id | (#PCDATA)> |

| | |
|---|---|
| <!ELEMENT section_description | (#PCDATA)> |
| <!ELEMENT section_note | (#PCDATA)> |

<!ELEMENT io_block (job_io_block_id, io_block_description,
io_block_action,
io_step+)>

| | |
|---|---|
| <!ELEMENT job_io_block_id | (#PCDATA)> |

| | |
|---|---|
| <!ELEMENT io_block_description | (#PCDATA)> |

| | |
|---|---|
| <!ELEMENT io_block_action | (#PCDATA)> |

<!ELEMENT io_step (job_io_step_id, io_step_description,
io_step_interface,
nominal_value,
nominal_value_units,
tolerance_maximum_value,
tolerance_minimum_value,
fail_response,
data_code,
test_id_prerequisite,
test_code_id,
performance_revision,
notes*
)>

| | |
|---|---|
| <!ELEMENT job_io_Step_id | (#PCDATA)> |

| | |
|---|---|
| <!ELEMENT io_step_description | (#PCDATA)> |
| <!ELEMENT io_step_interface | (#PCDATA)> |

| | |
|---|---|
| <!ELEMENT nominal_value | (#PCDATA)> |

| | |
|---|---|
| <!ELEMENT nominal_value_units | (#PCDATA)> |
| <!ELEMENT tolerance_maximum_value | (#PCDATA)> |
| <!ELEMENT tolerance_minimum_value | (#PCDATA)> |

| | |
|---|---|
| <!ELEMENT fail_response | (#PCDATA)> |

| | |
|---|---|
| <!ELEMENT data_code | (#PCDATA)> |

| | |
|---|---|
| <!ELEMENT test_id_prerequisite | (#PCDATA)> |

| | |
|---|---|
| <!ELEMENT test_code_id | (#PCDATA)> |

| | |
|---|---|
| <!ELEMENT performance_revision | (#PCDATA)> |

| | |
|---|---|
| <!ELEMENT notes | (#PCDATA)> |

The performance specification document also includes the following XML test execution specification:

```
<?xml version=“1.0” encoding=“utf-8”?>
<!DOCTYPE section PUBLIC “-//Test Requirements//EN”
“performance.dtd”>
<section>
<section_name_id>1</section_name_id>
<section_description>INSTRUMENTATION
BATTERIES </section_description>
<section_note></section_note>
  <io_block>
  <job_io_block_id>1</job_io_block_id>
  <io_block_description>OUTPUT:</io_block_description>
  <io_block_action>OUTPUT</io_block_action>
```

<io_step>
<job_io_step_id>1</job_io_step_id>
<io_step_description>MEASURE BATTERY
VOLTAGE</io_step_description>
<io_step_interface>DMM1</io_step_interface>
<nominal_value>12</nominal_value>
<nominal_value_units>VOLTS</nominal_value_units>
<tolerance_maximum_value>+2</tolerance_maximum_value>
<tolerance_minimum_value>−2</tolerance_minimum_value>
<fail_response>ALARM</fail_response>
<data_code>10000</data_code>
<test_id_prerequisite>0</test_id_prerequisite>
<test_code_id>4</test_code_id>
<performance_revision></performance_revision>
<notes>***VERIFY BATTERY VOLTAGE***</notes>

</io_block>
</section>

Reader R, in a specific example, comprises a commercially available XML text editor (e.g. Arbortext Epic Editor) and several ACL text scripts written to derive a tab delimited text file that reads the XML formatted performance specification document (PSD) and generates a tab-delimited configuration file for use with a Sun Solaris Workstation running the Solaris 8.0 operating system, Sybase Enterprise Server data base, and IONA Orbix common object broker architecture software. The Workstation is networked to an embedded VXI computer (VXI PC/700) with Windows NT 4.0 operating system, IONA Orbix common object broker architecture software, and NI/VISA VXI interface software. The embedded computer is connected via a common VXI chassis with an Agilent E1413C scanning A/D card as the voltage measurement device. The Workstation ingests the delimited configuration file and executes the voltage measurement via a common object broker architecture client and server. The client resident on the Workstation invokes server methods resident on the embedded computer to control execution of the voltage measurement and perform result evaluation.

At the selection of the operator, a document is produced from the XML document in human-readable form (e.g., formatted for ease of reading, such as through a word-processor or in columnar format) for quality control. For example, the human readable form document is published, in some embodiments, from the XML document using the Arbortext Epic Editor and ACL scripts. The general purpose test equipment includes a common object request broker architecture and a mark-up language enabled input that comprises reader R.

The above embodiments are given by way of example only. Further example embodiments will occur to those of skill in the art upon review of the present specification without departing from the spirit of the invention which is defined solely by the claims.

What is claimed is:

1. A general purpose test equipment system comprising:
hardware having common object request broker architecture software and
a mark-up language enabled input connected to the hardware.

2. A system as in claim 1 wherein the mark-up language enabled input generates a machine-ingestible document appropriate for configuring and controlling test equipment.

3. A system as in claim 1 wherein the mark-up language comprises XML.

4. A system as in claim 1 wherein the mark-up language comprises SGML.

5. A system as in claim 1 wherein the mark-up language comprises HTML.

6. A system as in claim 1 wherein the mark-up language enabled input comprises a mark-up language reader configured to receive a performance specification document and output a delimited configuration file.

7. A system as in claim 6 wherein the reader selectively outputs a human readable document corresponding to the performance specification document.

8. A system as in claim 6 wherein the performance specification document comprises:
an order of test operations to be performed on equipment, wherein the order of test operations is defined in mark-up language,
a specification of system interfaces for the application of stimulus to and the collection of measurements from the system during test operations, wherein the specification is defined in mark-up language,
a specification of units and values to be applied to the equipment during test operations, wherein the specification is defined in mark-up language,
a specification of units and values to be measured during test operations,
an identification of a test system response to failure, a specification for collection of test results, and
a specification for storage of test results.

9. A method of configuring test equipment comprising;
inputting, in mark-up language format:
an order of test operations,
a specification of system interfaces for the application of stimulus to and the collection of measurements from the system during test operations
units and values to be applied to the equipment during test operations,
units and values to be measured during test operations,
a test system response to a failure,
a specification of collection of test results,
a specification of storage of test results,
generating a delimited configuration file, dependent upon said inputting; and
entering the delimited configuration file into test equipment.

10. A method as in claim 9 wherein the mark-up language comprises SGML.

11. A method as in claim 9 wherein the mark-up language comprises XML.

12. A method as in claim 9 wherein the mark-up language comprises HTML.

13. A method as in claim 9 further comprising generating a human-readable document dependent upon said entering from the same XML source document used to generate the delimited configuration file.

14. A system of configuring test equipment comprising:
means for inputting, in mark-up language format:
an order of test operations,
a specification of system interfaces for the application of stimulus to and the collection of measurements from the system during test operations
units and values to be applied to the equipment during test operations,
units and values to be measured during test operations,
a test system response to a failure,
a specification of collection of test results,
a specification of storage of test results,
means for generating a delimited configuration file, dependent upon said means for inputting; and
means for entering the delimited configuration file into test equipment.

15. A system as in claim 14 wherein the mark-up language comprises SGML.

16. A system as in claim 14 wherein the mark-up language comprises XML.

17. A system as in claim 14 wherein the mark-up language comprises HTML.

18. A system as in claim 14 further comprising means for generating a human-readable document dependent upon said means for entering.
